(19) United States
(12) Patent Application Publication
(10) Pub. No.: US 2018/0292924 A1
(43) Pub. Date: Oct. 11, 2018

(54) INPUT PROCESSING APPARATUS

(71) Applicant: ALPS ELECTRIC CO., LTD., Tokyo (JP)

(72) Inventors: Kazuhito Oshita, Miyagi-ken (JP); Daisuke Takai, Miyagi-ken (JP); Hiroshi Shigetaka, Miyagi-ken (JP); Jo Ri, Miyagi-ken (JP); Hiroaki Takahashi, Miyagi-ken (JP)

(21) Appl. No.: 15/945,974

(22) Filed: Apr. 5, 2018

(30) Foreign Application Priority Data
Apr. 6, 2017 (JP) 2017-076310

(51) Int. Cl. G06F 3/0354; G06F 3/041

(52) U.S. Cl. CPC G06F 3/03547; G06F 3/041

(57) ABSTRACT

A detectable region having a large area is provided in an input panel below a surface panel. An input operation region is provided in part of the detectable region, and the position and the area of the input operation region can be changed within the detectable region. An input processing apparatus is provided with a responding force generator, and the responding force generator is set to different operation states between when a digit touches the input operation region and when a digit touches a non-operation region that is around the input operation region.

### CLAIM OF PRIORITY

This application claims benefit of priority to Japanese Patent Application No. 2017-076310 filed on Apr. 6, 2017, which is hereby incorporated by reference in its entirety.

### BACKGROUND

### 1. Field of the Disclosure

The present disclosure relates to an input processing apparatus provided with an input panel that outputs a detection signal based on a change in electrostatic capacitance.

### 2. Description of the Related Art

Japanese Unexamined Patent Application Publication No. 2010-257198 discloses an input processing apparatus provided with an input panel that outputs a detection signal based on a change in electrostatic capacitance.

In this input processing apparatus, the input panel is provided in front of a keyboard apparatus. On a surface side of the input panel, a semi-transparent surface panel is superposed, and on a rear surface side of the input panel, an operation display apparatus including light-emitting diodes and other components is provided.

The input panel includes a detection region in which coordinates at which a digit or the like touches or approaches can be detected, and part of the detection region can be set as a coordinate input region. When a digit touches a coordinate input apparatus, coordinate data corresponding to movement of the digit is generated, and when it is detected that a digit approaches a region other than the coordinate input region in the detection region, the detection signal is neglected.

When it is determined that a plurality of digits are touching the coordinates input apparatus, the coordinate input region can be moved in the direction of the movement of the digits. In addition, the operation display apparatus illuminates a region corresponding to the coordinate input region.

The input processing apparatus disclosed in Japanese Unexamined Patent Application Publication No. 2010-257198 can change the position of the coordinate input region, and it is possible to know the position of the coordinate input region by being illuminated by the operation display apparatus.

However, when it is not possible for an operator to give a glance at the coordinate input apparatus that is illuminated and displayed by the operation display apparatus, such as when the operator is performing an input operation while gazing at a display apparatus with concentration, the operator sometimes cannot intuitively know whether a region currently touching with a digit is the coordinate input apparatus. Therefore, a further improvement has been demanded.

### SUMMARY

An input processing apparatus includes an input panel configured to output a detection signal based on a change in electrostatic capacitance; and a responding force generator configured to give an operation responding force to the input panel. The input panel includes a detectable region in which an operated coordinate position is determinable on the basis of the detection signal, and the detectable region is divided into an input operation region and a non-operation region other than the input operation region. The responding force generator is set to different states between when a digit touches the input operation region and when a digit touches the non-operation region.

### BRIEF DESCRIPTION OF THE DRAWINGS

FIG. 1 illustrates a first embodiment of the present invention, and is a perspective view of a personal computer including an input processing apparatus;

FIG. 2 is a partial plan view of a detectable region in the input processing apparatus illustrated in FIG. 1;

FIG. 3 is a partial cross-sectional view of the input processing apparatus illustrated in FIG. 1;

FIG. 4 is a partial plan view illustrating an operation of moving an input operation region in the input processing apparatus illustrated in FIG. 1;

FIG. 5 is a partial plan view illustrating an operation of changing an area of the input operation region in the input processing apparatus illustrated in FIG. 1;

FIG. 6 illustrates examples of input setting panels displayed on a screen;

FIG. 7 is a circuit block diagram illustrating the input processing apparatus according to the first embodiment; and

FIG. 8 illustrates a second embodiment of the present invention, and is a partial perspective view of part of a compartment of an automobile including the input processing apparatus.

### DESCRIPTION OF THE EXEMPLARY EMBODIMENTS

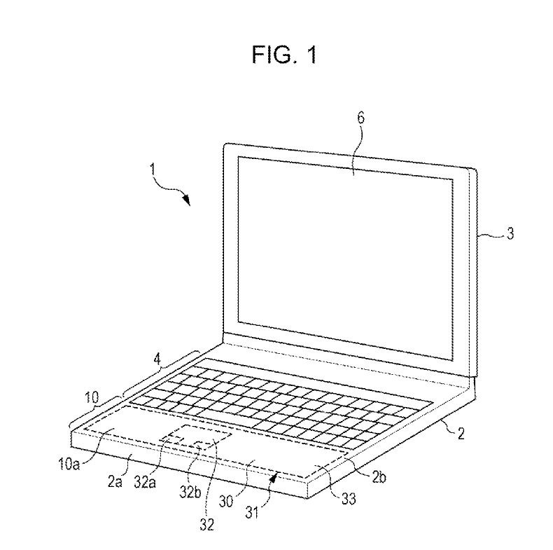

Now, a first embodiment of the present invention will be described. In a personal computer 1 of a laptop type illustrated in FIG. 1, a main body unit 2 and a lid part 3 are coupled to each other in such a manner that the personal computer 1 can be folded. The main body unit 2 is equipped with a keyboard apparatus 4 and an input processing apparatus 10, and the lid part 3 is equipped with a liquid crystal display apparatus 6.

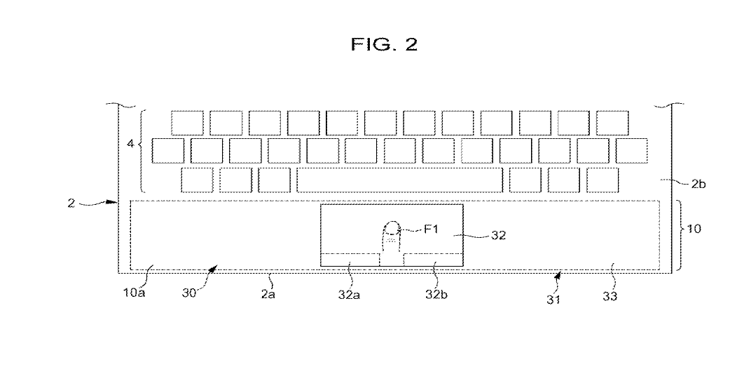

As illustrated in FIGS. 1 and 2, in the main body unit 2, the keyboard apparatus 4 having a plurality of input keys is disposed at a position close to the lid part 3, and the input processing apparatus 10 is disposed in front of the keyboard apparatus 4.

The input processing apparatus 10 is provided with an input panel 30. As illustrated in FIGS. 1 and 2, the input panel 30 occupies almost the entire region between a front edge portion 2a of the main body unit 2 and the keyboard apparatus 4. The input panel 30 is flat, and the width (length in the left-right direction in the drawings) of the input panel 30 is substantially equal to or greater than the width of the keyboard apparatus 4. Note that the input panel 30 is not necessarily flat and may be curved in accordance with the shape of an operation surface of a device to be mounted.

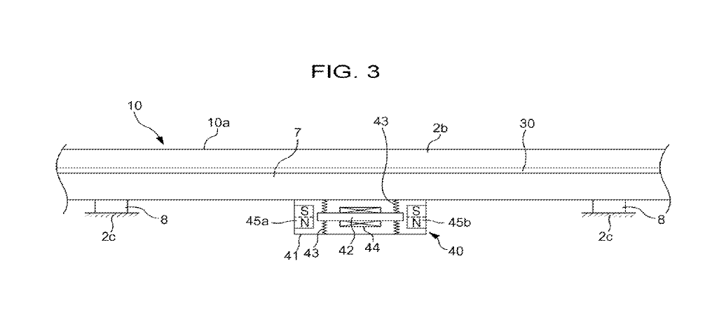

FIG. 3 is a partial cross-sectional view of the main body unit 2 at a portion where the input processing apparatus 10 is provided. The input processing apparatus 10 includes a surface panel 2b that appears on the surface of the main body unit 2, and the surface of the surface panel 2b serves as an operation surface 10a of the input processing apparatus 10. The surface panel 2b is formed of an acrylic resin and the like, and at least a portion covering the input panel 30 is light-transmissive. In addition, an operation display apparatus 7 is provided below (on the rear side of) the input panel 30.

The input panel 30 is mainly formed of a light-transmissive resin film and is in intimate contact with and fixed to the lower surface (rear surface) of the surface panel 2b. The surface panel 2b and the input panel 30 are transparent. The term “transparent” is defined as a total light transmittance of 90% or higher. Alternatively, the surface panel 2b and the input panel 30 are semi-transparent such that light emitted from the operation display apparatus 7 is observable from the outside of the surface panel 2b. For example, the surface panel 2b covering the input panel 30 is formed to have color similar to the color of the other part of the main body unit 2 and the lid part 3 and to be semi-transparent in such a manner that light from the operation display apparatus 7 can be transmitted.

The input panel 30 is an electrostatic capacitance detection panel. The input panel 30 includes a detectable region 31, which is a rectangular region surrounded by the dashed line in FIG. 2. In the detectable region 31 of the input panel 30, which is an electrostatic capacitance detection panel, on one or both of the surfaces of the light-transmissive resin film, a plurality of X electrodes and a plurality of Y electrodes are formed and intersect each other while being insulated from each other. A thin insulating layer is provided on the surfaces of these electrodes, and the surface of the insulating layer is in intimate contact with the rear surface of the surface panel 2b. Each of the above electrodes is an ITO layer, a conductive nanowire layer, a metal layer formed in the form of a mesh, or the like and can transmit light.

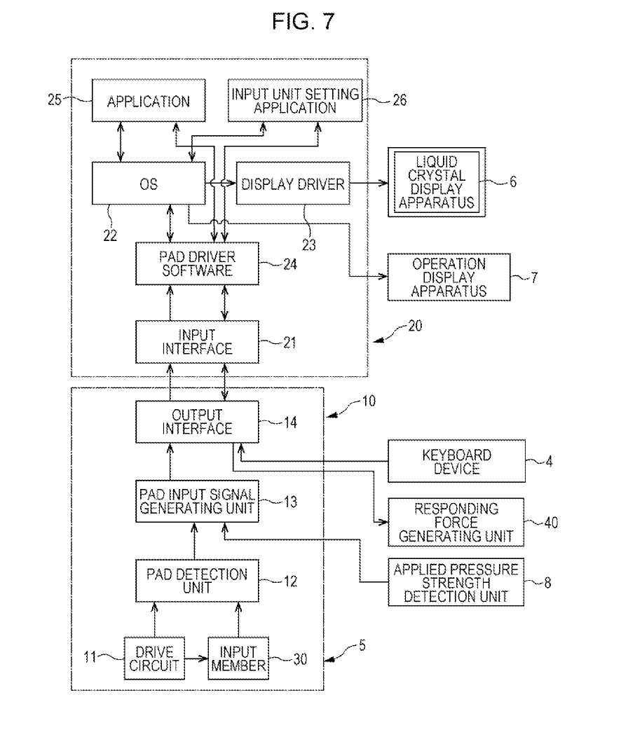

When a digit or a hand touches or approaches the operation surface 10a serving as the surface of the surface panel 2b, an electrostatic capacitance is formed between the digit or the hand and an electrode, and the electrostatic capacitance between an X electrode and a Y electrode changes. In the electrostatic capacitance detection panel, for example, either of the X electrodes and the Y electrodes serves as driving electrodes, and the other serves as detection electrodes. A drive circuit 11 illustrated in FIG. 7 sequentially applies a pulsed driving voltage to selected driving electrodes. At this time, a change in electric power from the detection electrodes is sequentially monitored by a pad detector 12 illustrated in FIG. 7, and the distribution of the electrostatic capacitance on the X-Y coordinates in the detectable region 31 is detected. Thus, the pad detector 12 can acquire information on the X-Y coordinates indicating which coordinate position in the detectable region 31 is the digit or hand's touching or approaching position on the surface panel 2b.

Note that it is also possible to use, as the electrostatic capacitance detection panel, a panel provided with three types of electrodes, which are a plurality of X electrodes, a plurality of Y electrodes, and a plurality of detection electrodes. In this case, a driving voltage is applied sequentially to the X electrodes or the Y electrodes, and a change in the electric power of the detection electrodes is sequentially monitored, thereby detecting the distribution of the electrostatic capacitance on the X-Y coordinates. Note that it is possible to use, for the electrostatic capacitance detection panel, not only the above-described mutual capacitance sensor, but also a self capacitance sensor in which each of the plurality of electrodes operates as a drive electrode and a detection electrode.

When a plurality of digits concurrently touch the surface panel 2b in the detectable region 31, in accordance with the timing for voltage application by the drive circuit 11 and an operation for processing a detection signal by the pad detector 12, the input panel 30 can detect the respective digits' touching or approaching positions as individual coordinate information. That is, a so-called multi-touch operation with digits can be detected. In addition, also when a palm approaches the detectable region 31, by calculating the detection area, the pad detection panel 12 can recognize whether a digit or digits are touching or approaching or a palm is touching or approaching.

In the input panel 30, an input operation region 32 in the form of a rectangle defined by a solid line in FIG. 2 can be set in the detectable region 31. The position of the input operation region 32 can be moved in the detectable region 31, and the size (area) thereof can also be changed. A region other than the input operation region 32 in the detectable region 31 is a non-operation region 33.

As illustrated in FIG. 7, the input processing apparatus 10 is provided with the operation display apparatus 7. The operation display apparatus 7 includes a plurality of light-emitting diodes and illuminates only the input operation region 32 illustrated in FIG. 2, or the input operation region 32 and the non-operation region 33 are illuminated with different hues and brightnesses. In either case, the detectable region 31 is illuminated from the rear side in such a manner that the contour of the input operation region 32, that is, a boundary portion (borderline) between the input operation region 32 and the non-operation region 33, is visually recognizable. In addition, if button operation regions 32a and 32b are provided inside or outside the input operation region 32 as illustrated in FIGS. 1 and 2, illumination may be performed in such a manner that the boundary portion between the button operation regions 32a and 32b and the input operation region 32 can be understood easily or the boundary portion between the button operation regions 32a and 32b and the non-operation region 33 can be understood.

It is possible to use, as the operation display apparatus 7, an electroluminescent device that can display an image of the contour of the input operation region 32, a device including a liquid crystal display panel a backlight mechanism provided therebelow, or the like.

As illustrated in the cross-sectional view of FIG. 3, the input processing apparatus 10 is provided with applied pressure detectors 8. The applied pressure detectors 8 are each a force sensor (pressure sensor), a piezoelectric element, or a piezoelectric sheet and are provided at a plurality of portions between a fixing and supporting unit 2c, which is provided in an inner bottom portion or other portion of the main body unit 2, and the operation display apparatus 7. Alternatively, the plurality of applied pressure detectors 8 are provided between the surface panel 2b and the fixing and supporting unit 2c. In the main body unit 2, the surface panel 2b can slightly be moved downward together with the input panel 30 and the operation display apparatus 7, and when the surface panel 2b is pushed in a region where the detectable region 31 is formed, the force is detected by the applied pressure detectors 8. Alternatively, push switches that detect applied pressures may be used as the applied pressure detectors 8. Further alternatively, part of the detectable region 31 may be formed so as to be movable downward via a hinge, and the moving force at this time may cause the applied pressure detectors 8 such as push switches to be operated.

As illustrated in FIG. 3, a responding force generator 40 is provided in the input processing apparatus 10. The responding force generator 40 is fixed to the rear side of the operation display apparatus 7. Alternatively, the responding force generator 40 is fixed to the rear side of the surface panel 2b in a region where the operation display apparatus 7 is not provided.

The responding force generator 40 includes a housing 41 that is fixed to the rear surface of the operation display apparatus 7, the rear surface of the surface panel 2b, or the like. Inside the housing 41, a vibrating body 42 is supported by a spring 43 so as to be capable of vibrating. The vibrating body 42 is a magnetic body, and the spring 43 is a leaf spring or a helical compression spring. A coil 44 is wound around the vibrating body 42. Inside the housing 41, a magnet 45a facing one end surface of the vibrating body 42, and a magnet 45b facing the other end surface are fixed. The magnet 45a and the magnet 45b have magnetized surfaces that are facing the vibrating body 42, the magnetized surfaces each having opposite polarities between the upper half and the lower half in the drawing. In addition, the magnet 45a and the magnet 45b have opposite magnetic poles in the left and right direction. When an alternating current flows in the coil 44, the magnetized vibrating body 42 vibrates in the vertical direction of the drawing. By managing a vibration continued period in this case, it is possible to make a digit or the like feel an operation responding force with various operation patterns, the digit having touched the operation surface 10a on the surface of the surface panel 2b. Note that in the responding force generator 40, the vibrating body 42 may be driven in a direction parallel to the operation surface 10a or may be operated in both the vertical direction of the drawing and in a direction parallel to the operation surface 10a.

FIG. 7 is a block diagram illustrating functional units stored in a control processor 20 of the main body unit 2 of the personal computer 1 and functional units provided in an integrated circuit 5 as an accessory of the input processing apparatus 10.

The integrated circuit 5 as an accessory of the input processing apparatus 10 is provided with the drive circuit 11 and the pad detector 12. As described above, the drive circuit 11 applies a pulsed voltage sequentially to the driving electrodes, which are either the X electrodes or the Y electrodes of the input panel 30. The pad detector 12 receives detection signals obtained from the detection electrodes, which are other of the X electrodes or the Y electrodes. The detection signals from the input panel 30 are processed by the pad detector 12, and a contact position of a digit that has touched the operation surface 10a on the surface of the surface panel 2b in the region where the detectable region 31 is formed is obtained as an operation signal, which is coordinate information on the X-Y coordinates.

The integrated circuit 5 is provided with a pad input signal generator 13. The pad input signal generator 13 converts the coordinate information (operation signal) that has been obtained by processing of the pad detector 12, into format data of a predetermined number of bytes and outputs the format data from an output interface 14. A key operation signal of the keyboard apparatus 4 is converted into predetermined format data by a keyboard input signal generator (not illustrated) and output from the output interface 14. In addition, in response to detection of an applied pressure by the applied pressure detector 8, the applied pressure detection output is also output from the output interface 14 as part of the operation signal.

The operation signal that is output from the output interface 14 is sent to an input interface 21 provided in the control processor 20 of the personal computer 1. A variety of kinds of software are stored in the control processor 20. An operating system (OS) 22 is stored in the control processor 20. By the operating system 22, a display driver 23 is controlled, and various kinds of information are displayed on the liquid crystal display apparatus 6 provided in the lid part 3. In addition, as illustrated in FIG. 3, the operation display apparatus 7 provided below the input panel 30 is also controlled by the operating system 22.

In the control processor 20, pad driver software 24 is installed, and an operation signal received by the input interface 21 is sent to the pad driver software 24. In the pad driver software 24, on the basis of the operation signal in the predetermined format transmitted from the pad input signal generator 13, a coordinate data signal equivalent to an operation signal of a mouse, which is an external device, is generated and sent to the operating system 22. The operation signal sent from the keyboard apparatus 4 is sent through the pad driver software 24 or other driver software to the operating system 22.

By the pad driver software 24, it can be determined whether an input operation is performed by a single digit touching the surface panel 2b, a plurality of digits concurrently touching the surface panel 2b, or a palm touching the surface panel 2b. If the pad driver software 24 recognizes the area of an electrically conductive body approaching the input panel 30 being smaller than or equal to a predetermined value, the electrically conductive body having a single touching portion, it is determined that the input operation is performed by a single digit, and if the pad driver software 24 recognizes the area of an electrically conductive body approaching the input panel 30 being smaller than or equal to the predetermined value, the conductive body having a plurality of touching portions, it is determined that the input operation is performed by a plurality of digits. In addition, if the pad driver software 24 recognizes the area of an electrically conductive body approaching the input panel 30 being greater than or equal to the predetermined value, it is determined that the input operation is performed by a palm that has touched. It is also possible to determine whether the input operation is performed by a digit or a palm by other calculation methods not using the touching area.

As illustrated in FIG. 7, various kinds of application software 25 are installed in the control processor 20. The application software 25 may be word processor software, various kinds of calculation software, game software, communication software, or the like.

The control processor 20 is provided with input panel setting application software 26. On the basis of the operation signal sent from the keyboard apparatus 4 or the operation signal sent from the input panel 30, the input panel setting application software 26 changes the position and size of the input operation region 32 in the detectable region 31. In addition, the operation display apparatus 7 controls illumination in such a manner that the input operation region 32 is recognizable. Furthermore, the input panel setting application software 26 generates a responding force setting signal. The responding force setting signal is sent through the input interface 21 and the output interface 14 to the responding force generator 40.

Next, an operation method of the input processing apparatus 10 will be described.

The input processing apparatus 10 can detect a digit or a hand touching or approaching the surface panel 2b in the detectable region 31 of the input panel 30.

By a control operation of the input panel setting application software 26, as illustrated in FIG. 2, part of the detectable region 31 is set as the input operation region 32, and the remaining region in the detectable region 31 is set as the non-operation region 33. In response to this setting, the pad driver software 24 determines that an input operation is performed only when a digit approaching the input operation region 32 is detected, and an operation signal is generated. When a digit or a palm approaches the non-operation region 33, the pad driver software 24 recognizes the approach of the digit or the palm to the non-operation region 33; however, after the recognition, detection signals from the input panel 30 are neglected, and the non-operation region 33 is set as an insensitive region.

By setting the region other than the input operation region 32 as the insensitive region, even when a digit or a palm touches the non-operation region 33 while, for example, the keyboard apparatus 4 is operated, the detection signals can be neglected, and only operation signals within the input operation region 32 can be extracted.

As illustrated in FIG. 2, the button operation regions 32a and 32b can be set to the left and right in the input operation region 32. Note that the button operation regions 32a and 32b may be set outside the input operation region 32, at a location near the input operation region 32 in the non-operation region 33.

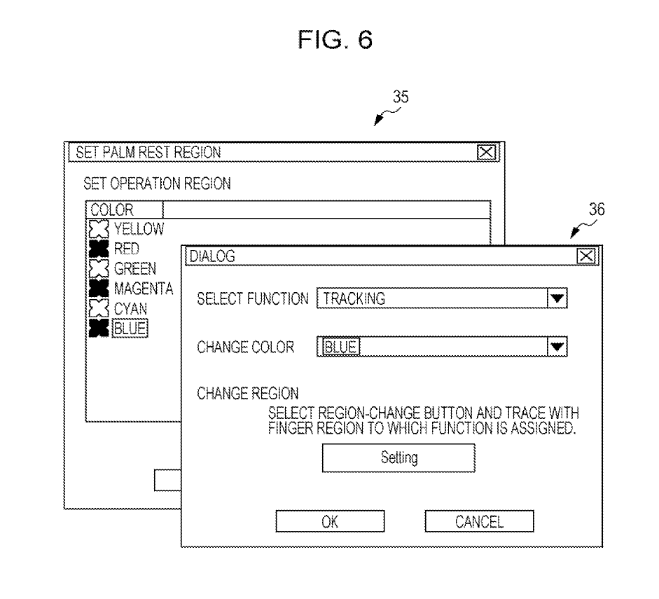

The input operation region 32 and the button operation regions 32a and 32b are set by operation of the keyboard apparatus 4 or operation of any region in the input panel 30 and accessing the input panel setting application software 26. In response to the input panel setting application software 26 being accessed, the display driver 23 is driven by the operating system 22, and as illustrated in FIG. 6, input setting panels 35 and 36 are displayed on a display screen of the liquid crystal display apparatus 6. By performing an operation in accordance with instructions made on the input setting panels 35 and 36 by using the keyboard apparatus 4 or the input panel 30, it is possible to change the size, shape, or position of the input operation region 32. In addition, it is possible to set or change operation functions to be assigned to the left and right button operation regions 32a and 32b. Similarly, it is possible to set or change the positions or areas of the button operation regions 32a and 32b.

Furthermore, by operating the input setting panels 35 and 36, it is possible to select whether the input operation region 32 is to be illuminated so as to be distinguished from the non-operation region 33. Moreover, for example, it is possible to set the hue or change the brightness of the input operation region 32, the non-operation region 33, and the button operation regions 32a and 32b that are to be illuminated and displayed on the surface panel 2b by the operation display apparatus 7.

As illustrated in FIG. 2, if the input operation region 32 is set in the detectable region 31, with the illumination from the operation display apparatus 7, the operator can visually distinguish the input operation region 32 from the non-operation region 33.

If a single digit touches and moves the rectangular input operation region 32 located in the detectable region 31, the coordinate data thereof is detected by the pad detector 12 and output as predetermined format data by the pad input signal generator 13. On the basis of the coordinate data, the pad driver software 24 generates an input signal that is equivalent to an input signal obtained when a mouse is operated, and the input signal is sent to the operating system 22. Then, in accordance with an application that has been started, for example, the following operations are possible: a cursor displayed on a screen of the liquid crystal display apparatus 6 is moved, a menu is selected, a character is handwritten, and a game is controlled. In addition, it is also possible to send an input signal to the application by touching the input operation region 32 with two or three digits.

While the pad detector 12 detects that a single digit is touching any one of the button operation regions 32a and 32b illustrated in FIG. 2, upon the surface panel 2b being pushed with the digit touching the one of the button operation regions 32a and 32b, the applied pressure is detected by the applied pressure detectors 8 illustrated in FIG. 3. At this time, a left button operation signal or a right button operation signal is generated by the pad input signal generator 13 and sent to the pad driver software 24. The pad driver software 24 generates an operation signal that is substantially the same as an operation signal obtained when a left button or a right button attached on a mouse is pushed, and the operation signal is sent to the operating system 22.

Note that when a user operates the keyboard apparatus 4 with both hands, the palms are often placed on the non-operation region 33 of the detectable region 31. In this case, it may be erroneously determined that an input operation is performed. Accordingly, once it is determined that a digit or a palm is touching or approaching the non-operation region 33 of the detectable region 31, the pad driver software 24 recognizes the touch in the non-operation region 33, but neglects operation signals related to coordinate data from the non-operation region 33 and sets the non-operation region 33 as the insensitive region.

If the input panel setting application software 26 illustrated in FIG. 7 is started, the input operation region 32 that has been set can be moved within the detectable region 31, and the area of the input operation region 32 can be changed. As described above, these operations can be performed on the displayed input setting panels 35 and 36 illustrated in FIG. 6 and by inputting predetermined items.

Alternatively, by operating the input operation region 32 with a digit, the input operation region 32 can be moved within the detectable region 31, and the area of the input operation region 32 can be changed. For example, as illustrated in FIG. 2, when the input operation region 32 is touched by a single digit F1 to be operated, the pad driver software 24 determines that a normal input operation is performed, and generates a signal in accordance with the movement of the single digit F1, the signal being equivalent to a signal obtained when a mouse is operated. Also, when the input operation region 32 is touched by two digits, a normal input operation is performed in a multi-touch mode.

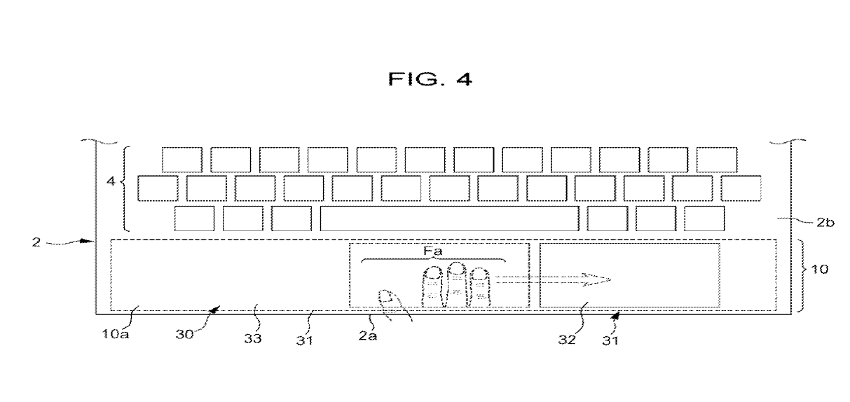

As illustrated in FIG. 4, when a group of digits Fa that are three or more digits moves together while touching the input operation region 32, the pad driver software 24 recognizes an operation for moving the input operation region 32. At this time, the input panel setting application software 26 is accessed, a process for moving the input operation region 32 in the direction of movement of the group of digits Fa is performed, and the input operation region 32 is set at a new location.

Alternatively, when an internal region or a vicinity of the input operation region 32 is tapped or double-tapped by two digits or the group of digits Fa that are three or more digits, immediately followed by movement of the two digits or the group of digits Fa that are three or more digits, a process for moving the input operation region 32 may be performed. In addition, after the completion of movement, when tapping or double-tapping is performed again, the position of the input operation region 32 may be determined. Further alternatively, when a pressure that is applied to the input operation region 32 by two digits or the group of digits Fa that are three or more digits is detected by the applied pressure detectors 8, immediately followed by movement of the two digits or the group of digits Fa that are three or more digits, a process for moving the input operation region 32 may be performed. In addition, after that, when an applied pressure is detected again, the position of the input operation region 32 may be determined.

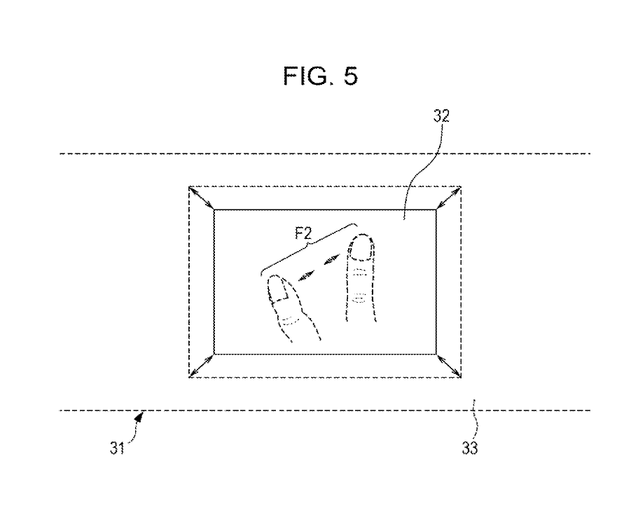

In addition, as illustrated in FIG. 5, when the internal region or the vicinity of the input operation region 32 is touched by two digits, for example, a group of digits F2 that are a thumb and a forefinger, and the distance between the two digits is changed, the area of the input operation region 32 in the detectable region 31 can be changed. For example, immediately after the input operation region 32 is tapped or double-tapped by the group of two digits F2, by increasing the distance between the two digits F2, the area of the input operation region 32 is increased; by decreasing the distance between the two digits F2, the area of the input operation region 32 is decreased. After that, by performing tapping or double-tapping, the size of the input operation region 32 is determined.

Alternatively, as illustrated in FIG. 4, when the internal region or the vicinity of the input operation region 32 is touched by the group of three or more digits Fa, by increasing the distance between the plurality of digits, the area of the input operation region 32 may be increased; by decreasing the distance between the plurality of digits, the area of the input operation region 32 may be decreased. In addition, it is possible to move the input operation region 32 or to change the area of the input operation region 32 by changing the number of digits touching the detectable region 31, by moving the digits, by combining the number of touching digits, the movement of the digits, and a pressure applying operation, or the like.

As illustrated in FIG. 2, in a case in which the left and right button operation regions 32a and 32b are set inside the input operation region 32, as illustrated in FIG. 4, the button operation regions 32a and 32b can be set so as to be moved in accordance with the movement of the input operation region 32. Also, as illustrated in FIG. 5, the areas of the button operation regions 32a and 32b may be changed in accordance with the change of the area of the input operation region 32. The above technique is also applicable in a case in which the button operation regions 32a and 32b are set outside the input operation region 32. In this case, it is also possible to select the presence and absence of the button operation regions 32a and 32b, to move the input operation region 32, or to change the area of the input operation region 32 by changing the number of digits touching the detectable region 31, by moving the digits, by combining the number of touching digits, the movement of the digits, and a pressure applying operation, or the like.

Once the position and area of the input operation region 32 in the detectable region 31 is determined through the above operation, setting information is sent through the operating system 22 to the operation display apparatus 7. With an illuminating operation of the operation display apparatus 7, the input operation region 32 is displayed with a hue and a brightness different from those in the other regions, and thereby the position of the operation display apparatus 7 is visually recognizable. Alternatively, the button operation regions 32a and 32b may be illuminated so as to be distinguished from the other regions.

In addition, on the basis of the setting information of the input operation region 32 and coordinate information (operation signal) currently obtained from the pad input signal generator 13, the input panel setting application software 26 generates a responding force driving signal. The responding force driving signal is sent through the input interface 21 and the output interface 14 to the responding force generator 40. Alternatively, the responding force driving signal may be directly sent to the responding force generator 40 from the operating system 22 of the control processor 20.

With the responding force driving signal, the responding force generator 40 is set to different states between when the single digit F1, two digits, or the like touches the input operation region 32 as illustrated in FIG. 2 and when the single digit F1, two digits, or the like touches the non-operation region 33. The operation of the responding force generator 40 at this time will be described below.

(1) In response to detection of touch of a digit in the input operation region 32, a driving signal is sent to the responding force generator 40, the responding force generator 40 is driven, and an operation responding force is given to the input panel 30 and the surface panel 2b on the surface side of the input panel 30. Note that if it is determined that the digit is touching somewhere in the non-operation region 33, the responding force generator 40 is not driven.

At the time of the detection of touch of a digit in the input operation region 32, a first touch may be defined. For example, after the power of the input processing apparatus 10 is turned on, the time at which a digit initially touches the detectable region 31 is set as a first touch. Alternatively, after a predetermined period elapses after the last-time detection of a digit that has touched on the detectable region 31, the time at which a digit touches the detectable region 31 is set as a first touch. Further alternatively, while a digit touching the detectable region 31 is detected, when the coordinate position of the detected digit suddenly moves to a position that is away by a predetermined distance or more, the time of the movement is set as a first touch. This corresponds to a state in which a digit that has touched the surface panel 2b becomes distant and then immediately touches the surface panel 2b again.

If it is determined that a digit's first touch is made in the input operation region 32 by the pad driver software 24 and the input panel setting application software 26, an alternating-current driving signal at a predetermined frequency is given to the coil 44 of the responding force generator 40 for a short period, and the vibrating body 42 vibrates for a short period. The vibrations for a short period may be repeated a plurality of times, or the vibrations may be continued for a predetermined period.

A responding force generated by the responding force generator 40 is given from the operation surface 10a on the surface of the surface panel 2b to the digit, and thereby the operator can tactilely determine that the operator is operating somewhere in the input operation region 32.

After the responding force generator 40 is driven in response to the determination of a first touch of a single digit initially touching the input operation region 32, with the digit continuously touching the input operation region 32, when another digit touches the input operation region 32, the other digit's touch is determined as the first touch, and the responding force generator 40 is driven again. Note that if it is determined that a touch position of the other digit is in the non-operation region 33, the other digit's touch is not determined as the first touch, and the responding force generator 40 is not driven.

In the above operation, when the operator touches the surface panel 2b with a single digit, he/she can understand that he/she is operating the input operation region 32 by feeling the responding force on the digit. In addition, when an operation with a single digit shifts to an operation with two digits, which is a multi-touch operation, he/she can immediately understand that the multi-touch region is the input operation region 32 by feeling the responding force on the second digit.

When it is determined that a digit's first touch is made in any one of the button operation regions 32a and 32b, the responding force generator 40 may be operated. At this time, the responding force generated by the responding force generator 40 is preferably different from the responding force generated when the first touch is made in the input operation region 32 and different from the responding force generated when the first touch is made in the non-operation region 33. As illustrated in FIG. 4, since the input operation region 32, the non-operation region 33, and the button operation regions 32a and 32b are set on the same operation surface 10a, and it is not possible to distinguish the regions by only touching a region with a digit. Accordingly, responding force generated when a digit touches is set in different modes according to regions, and thus, the region where the digit is touching is clearly understandable.

Note that the present invention is not limited to the technique of driving the responding force generator 40 at the time of a digit's touch defined as the first touch. For example, the responding force generator 40 may be operated after a predetermined period elapses after detection of the first touch of a digit that has touched the input operation region 32 or the button operation regions 32a and 32b; or, the responding force generator 40 may be operated when a digit repeatedly touches the input operation region 32 or the button operation regions 32a and 32b a plurality of times. That is, a digit's touching operation that is not defined as the first touch can cause the responding force generator 40 to be operated.

Note that although it may be determined by the pad driver software 24 and the input panel setting application software 26 whether a digit has touched the input operation region 32 for each time, when the coordinate position of the input operation region 32 is determined, the information thereof may be sent to the input processing apparatus 10 and the coordinate position of the input operation region 32 may be retained by firmware of the input processing apparatus 10. If the setting is made in this manner, it is possible to quickly determine whether a digit is touching the input operation region 32, for example, whether a first touch is made, only by the input processing apparatus 10.

(2) In response to detection of touch of a digit (e.g., detection of the first touch) in the input operation region 32, the responding force generator 40 is driven, and then, while an input operation is performed by the digit moving within the input operation region 32, movement of the digit touch position to the boundary portion between the input operation region 32 and the non-operation region 33 causes the responding force generator 40 to be driven. This operation can warn the operator of a state in which the operating digit that is touching and operating the input operation region 32 deviates from the input operation region 32.

At this time, when the digit arrives at the boundary portion between the input operation region 32 and the non-operation region 33, the responding force generator 40 may be driven. Alternatively, immediately after the digit deviates from the input operation region 32 and arrives in the non-operation region 33, the responding force generator 40 may be driven. Note that the responding force generator 40 is preferably driven immediately before the digit touch position arrives at the boundary position from the input operation region 32. If the setting is made in this manner, it is possible to give a responding force immediately before the digit touch position deviates from the input operation region 32, and to warn the operator to prevent the digit from deviating from the input operation region 32.

Note that after detection of the digit touch position arriving in the non-operation region 33 of the detectable region 31, the pad driver software 24 neglects detection signals in the non-operation region 33, and the non-operation region 33 is set as the insensitive region.

(3) Operation responding forces in different modes are given from the responding force generator 40 to the input panel 30 and the surface panel 2b between when the input operation region 32 is operated and when the non-operation region 33 is operated.

For example, when it is determined that a digit has touched the input operation region 32 (e.g., when the first touch in the input operation region 32 is determined), the responding force generator 40 is operated in a pulsed manner for only a short period; when it is determined that a digit has touched the non-operation region 33 (e.g., when the first touch in the non-operation region 33 is determined), the responding force generator 40 is operated for a long period. Alternatively, if it is determined that a digit has touched the input operation region 32, the responding force generator 40 may refrain from being operated, and only if it is determined that a digit has touched the non-operation region 33, the responding force generator 40 may be operated. If a responding force is given only when a digit touches the non-operation region 33, it is possible to immediately recognize that the digit deviates from the input operation region 32.

If the responding force generator 40 is operated when a digit touches the non-operation region 33, the non-operation region 33 is preferably set as the insensitive region after the operation of the responding force generator 40.

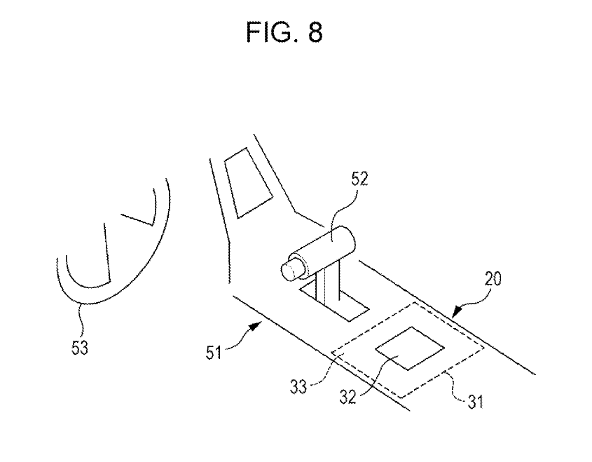

FIG. 8 illustrates a second embodiment of the present invention. FIG. 8 illustrates the inside of a compartment of an automobile.

Inside the compartment of the automobile, a console box 51 is provided by the side of a steering wheel 53. The input processing apparatus 10 is provided above the console box 51 in front of a shift lever 52. The input processing apparatus 10 has the same configuration as that in the first embodiment illustrated in FIGS. 1 to 7 and is controlled in the same manner.

That is, part of a surface panel of the console box 51 is transparent or semi-transparent, and the input panel 30 and the operation display apparatus 7 are disposed inside the surface panel. The surface of the surface panel serves as an operation surface, and the detectable region 31 is set. The detectable region 31 is divided into the input operation region 32 and the non-operation region 33. With a digit or hand operation, the position of the input operation region 32 can be moved, and the area of the input operation region 32 can be changed.

The responding force generator 40 is set to different operation states between when a digit touches the input operation region 32 and when a digit touches the non-operation region 33. Thus, it is possible for a driver to correctly operate the input operation region 32 while watching forward without glancing at the input processing apparatus 10.

The input processing apparatus 10 according to an embodiment of the present invention can be used for a mobile information processing apparatus, a game console, and the like in addition to the above embodiments.

In addition, the operation display apparatus 7 is not necessarily provided.

What is claimed is:

1. An input processing apparatus comprising:
an input panel configured to output a detection signal based on a change in electrostatic capacitance; and
a responding force generator configured to give an operation responding force to the input panel,
wherein the input panel includes a detectable region in which an operated coordinate position is determinable on the basis of the detection signal, and the detectable region is divided into an input operation region and a non-operation region other than the input operation region, and
wherein the responding force generator is set to different states between when a digit touches the input operation region and when a digit touches the non-operation region.

2. The input processing apparatus according to claim 1,
wherein the responding force generator is operated in response to detection of touch of a digit in the input operation region.

3. The input processing apparatus according to claim 2,
wherein the input panel detects a plurality of digits concurrently, and
wherein the responding force generator is operated in response to detection of touch of a digit in the input operation region, and continuously, the responding force generator is operated again in response to detection of touch of another digit in the input operation region.

4. The input processing apparatus according to claim 1,
wherein the responding force generator is operated when a coordinate position at which a digit is detected moves from the input operation region to a boundary portion between the input operation region and the non-operation region.

5. The input processing apparatus according to claim 4,
wherein the responding force generator is operated immediately before the coordinate position arrives at the boundary portion from the input operation region.

6. The input processing apparatus according to claim 2,
wherein the non-operation region is set as an insensitive region.

7. The input processing apparatus according to claim 1,
wherein at least one of a position and an area of the input operation region is capable of being changed.

8. The input processing apparatus according to claim 1,
wherein the responding force generator generates different operation responding forces between when the input operation region is operated and when the non-operation region is operated.

9. The input processing apparatus according to claim 8,
wherein the responding force generator is operated only when the non-operation region is operated.

10. The input processing apparatus according to claim 8,
wherein the non-operation region is set as an insensitive region after operation of the responding force generator.

11. The input processing apparatus according to claim 1,
wherein in the detectable region, a button operation region is settable inside or outside the input operation region, and when the button operation region is operated, the responding force generator generates a responding force that is different from a responding force generated when a digit touches the input operation region.

12. The input processing apparatus according to claim 11,
wherein when the button operation region is operated, the responding force generator generates a responding force that is different from a responding force generated when a digit touches the non-operation region.

13. The input processing apparatus according to claim 11,
wherein at least one of a position and an area of the button operation region is capable of being changed.
